(19) United States
(12) Patent Application Publication
(10) Pub. No.: US 2010/0166476 A1
(43) Pub. Date: Jul. 1, 2010

(54) DATA ENTRY INTERFACE FOR USE WITH AN ELECTRONIC DEVICE

(76) Inventor: Roger J. B. Jellicoe, Chicago, IL (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 12/344,681

(22) Filed: Dec. 29, 2008

(51) Int. Cl. B41J 5/00

(52) U.S. Cl. 400/489

(57) ABSTRACT

A data entry interface for use with an electronic device (200) includes a first row of keys that have a first group of letters (1^{A}, 2^{A}, 3^{A}, 4^{A}, and 5^{A}) and a second group of letters (1_{B}, 2_{B}, 3_{B}, 4_{B}, and 5_{B}) that are horizontally offset from the first group of letters. A second row of keys are positioned below the first row of keys and have a third group of letters (6^{A}, 7^{A}, 8^{A}, 9^{A}, 10^{A}) and fourth group of letters (6_{B}, 7_{B}, 8_{B}, 9_{B}, 10_{B}) such that the third group of letters are vertically aligned with the first group of letters and the second group of letters are vertically aligned with the second group of letters. A third row of keys are positioned below the second row of keys having a fifth group of letters (11^{A}, 12^{A}, 13^{A}, 14^{A}, 15^{A}) and sixth group of letters (11_{B}, 12_{B}, 13_{B}, 14_{B}, 15_{B}) such that the fifth group of letters are vertically aligned with the first group of letters and third group of letters and the sixth group of letters are vertically aligned with the second group of letters and fourth group of letters.

### FIELD OF THE INVENTION

The present invention relates generally to keyboards and more particularly to a modified QWERTY keyboard used with an electronic device

### BACKGROUND

Many differing keyboards have been used in connection with electronic devices, such a personal computer, cellular telephones, and personal digital assistants. When used in connection with an electronic device, keyboards are often ergonomically located on the device to allow a comfortable, neutral posture during use. Due to the small nature of portable electronic devices, it is often difficult for a user to comfortably use its keyboard while still typing in rapid and efficient manner. Probably most well known is the standard keyboard configuration best known as the QWERTY keyboard. The name QWERTY is derived from the first six characters on the top alphabetic line of the keyboard. The arrangement of characters on a QWERTY keyboard was designed in 1868 by Christopher Sholes, the inventor of the typewriter. The problem in adapting the QWERTY keyword for use with mobile and portable electronic devices is the size and shape of the QWERTY keyboard. For example, when adapted to a cellular phone, the QWERTY keyboard is often configured too large in size to be useful to the user. Moreover, as the keyboard is reduced in size, the user may have difficulty typing alpha text messages in a rapid manner. Consequently, differing types of alternative designs have been invented to assist in this task.

A keyboard designed for speed typing is the Dvorak keyboard that was designed around 1930. August Dvorak was a professor of education and designed the keyboard so that the middle row of keys includes the most commonly used letters. In addition, common letter combinations are positioned in such a way that they can be typed quickly. The problem with this type of keyboard is that its configuration and letter combinations are unfamiliar to the general public. This requires users to re-learn the positions of the keys which users find burdensome and are unwilling to do since they are more familiar with the QWERTY configuration. Consequently, different types of keyboards for mobile electronic devices have been developed that use variants of the QWERTY configuration. These include 6×4 (+2), 5×5 (+1), and 4×6 (+2) matrix configurations where the letters are typically organized in alphabetic order.

On such alternative design is set forth in U.S. Pat. No. 7,216,588 entitled “Modified-Qwerty Letter Layout for Rapid Data Entry,” which is herein incorporated by reference. This type of QWERTY keyboard design utilizes a 5×6 matrix-like pattern of the alphabet where each of the three rows of the standard QWERTY design are split into two rows. As seen in prior art FIG. 1, the QWERTY sequence, which normally would be linearly aligned along a top single row, is split into two rows so that the letter pairs Q-W, E-R, T-Y, U-I, and O-P are split into the first and second rows of the keyboard. Similarly, this also occurs with the middle or “home” row as well as the lower row of the standard QWERTY design. The keys are non-staggered and linearly aligned with one another to form a 5×6 matrix-like keypad.

Although users can demonstrate that alphanumeric text messages can be created at higher speeds than some of these alternative designs, this type of arrangement is still problematic since the user must relearn the QWERTY configuration which has been reconfigured or split into alternating rows of letters. Many users find re-learning this modified QWERTY configuration in order to type at rapid speeds as an undesirable aspect of this design. Consequently, better designs are being developed to enable the users to better facilitate use of their mobile devices.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a prior art diagram illustrating a QWERTY keyboard design where rows are split so that they are non-staggered and linearly aligned in a 5×6 matrix-like configuration.

FIG. 2 is a diagram illustrating a 5×3 keyboard matrix where each block of the matrix represents a single key of the keyboard.

FIG. 3 is diagram illustrating the QWERTY keyboard for use with an electronic device in accordance with an embodiment of the present invention.

FIGS. 4-6 illustrate various keyboard designs using the modified keyboard design of the present invention.

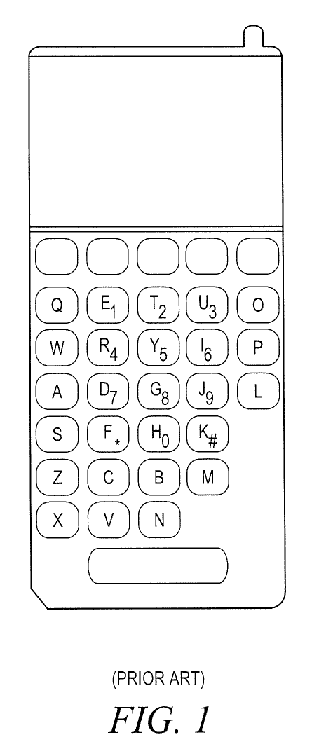

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to a QWERTY keyboard used with an electronic device. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

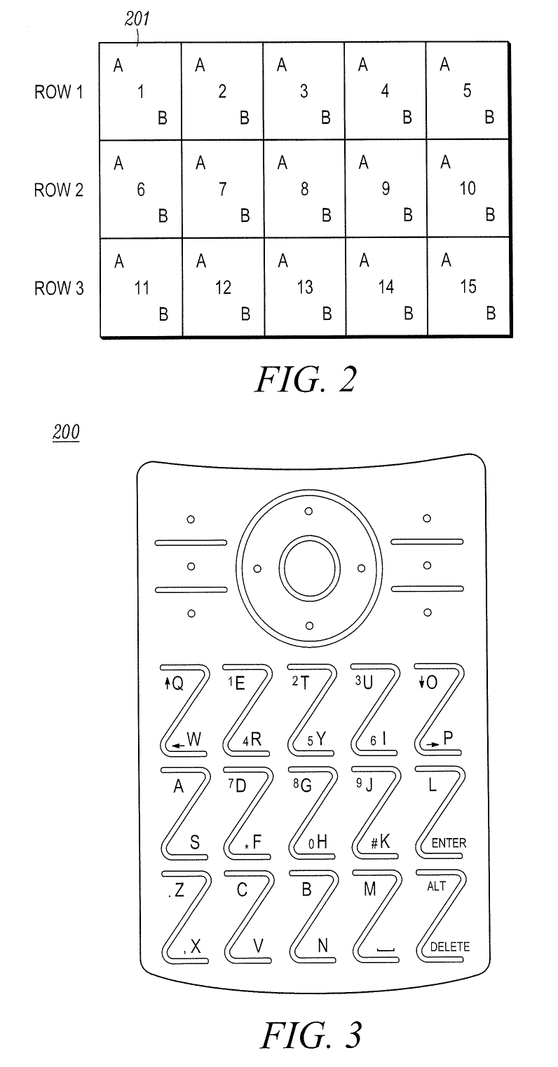

FIG. 2 illustrates the general layout of a 5×3 keyboard matrix 200 where each block of the matrix represents a single key 201 of a plurality of keys. Each key includes a first position (A) and second position (B) to form row pairs 1^{A}/1_{B}, 2^{A}/2_{B} and 3^{A}/3_{B}. Each of the A and B positions on each key work as actuator switch positions where both the A and B positions on each key are staggered, horizontally offset, and/or not linearly aligned. As used herein the term “vertically aligned” means alpha characters, numerals, or symbols that are placed, operate, or act chiefly in a vertical direction, such as any two adjoining alpha characters, numerals, and/or symbols are in linear alignment on the keyboard matrix. Similarly, the term “horizontally offset” means alpha characters, numerals, or symbols that are placed, operate, or act in a horizontal direction such as any two adjoining alpha characters, numerals, and/or symbols that are not in linear alignment horizontally on the keyboard matrix. Each switch actuator performs some individual functionality, such as entry of an individual letter or the performance of a keyboard function such as a letter space, delete, enter, or use of an alternative (Alt) keyboard. Therefore, of the fifteen keys having A and B actuator positions, there are at least thirty overall individual letters and/or functions that can be selected using the keyboard. Those skilled in the art will recognize that using one or more Alt keys, deterring key pressing times, or button presses can add even more keyboard functionality.

FIG. 3 illustrates a data entry interface of a modified QWERTY keyboard for use with an electronic device in accordance with an embodiment of the invention. The keyboard 200 includes a row 1^{A} of letters consisting of the letter Q, E, T, U, O and row 1_{B} having letters W, R, Y, I, and P. Although the keyboard 200 uses letters organized in a modified QWERTY configuration, the letters are staggered and horizontally offset to look like a standard matrix of letters as used in the prior art. Similarly, row 2A consists of the letters A, D, G, J, and L. Row 2B is paired with row 2A and consists of the letters S, F, H, and K. These letters in row 2B are also staggered and horizontally offset with those of the row 2A. Row 3A consists of the letters Z, C, B, and M and are vertically aligned with the letters in rows 1A and 2A. Similarly, row 3B is paired with row 3A and consists of the letters X, V, and N that are vertically aligned with the letters rows 1B and 2B.

As seen in FIG. 3, with each row pair, namely rows 1A/1B, 2A/2B, and 3A/3B, the letters are positioned on the same key. Although shown as a 5×3 matrix of keys, it will be further evident to those skilled in the art that each letter may placed on an individual key forming a 5×6 matrix where each of the alternating rows of key pairs are staggered so that letters are horizontally offset. In this alternative arrangement, the letters in rows 1, 3, and 5 would be vertically aligned and the letters in rows 2, 4, and 6 would be vertically aligned. In use and in either embodiment, the overall appearance of this type of staggered arrangement of the QWERTY letters is more user friendly to that of a standard QWERTY design. Due to its compact size, this 5×3 key configuration lends itself very well for use with many types of small, portable, battery-operated electronic device. As seen in FIG. 3, additional keyboard functionality can be added where an enter control is added to row 2_{B}, an “Alt” control is added to row 3^{A}, while the space “I_I” and “Delete” functions are added to row 3_{B}. Although in this modified QWERTY type keyboard the letters are split between alternating rows, their appearance in this staggered configuration provides a visual queue or familiarity to the user. Therefore, the overall grouping of letters are similar in appearance to those if viewed on a standard QWERTY keyboard. Thus, the user is not left to re-learn a new keyboard configuration, as in prior art designs, since the letters are staggered and identifiable. This enables the user to visualize the familiar QWERTY sequence almost as if it were used in a linear fashion giving them the ability to type alphanumeric text messages at a much higher rate of speed as compared with modified QWERTY designs used in the prior art.

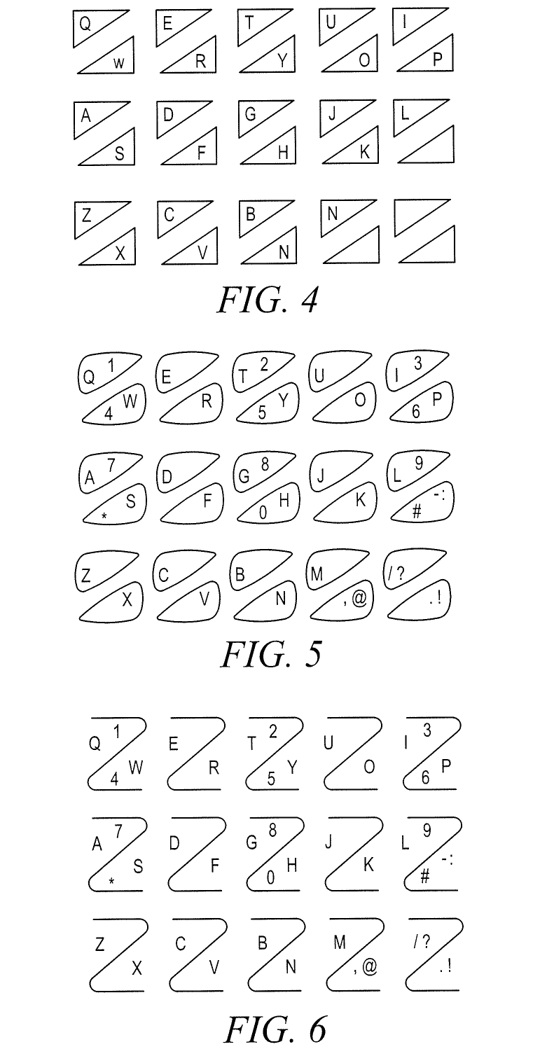

FIGS. 4-6 illustrate various keyboard designs using the modified keyboard design of the present invention. More specifically, FIG. 4 illustrates keys that are triangular shaped, FIG. 5 illustrates keys as teardrop shaped having a wide and tapered end. FIG. 6 is like that shown in FIG. 4 and illustrates keys whose letters are separated by a reverse S-type separator or divider. In each embodiment, the user is free to choose the type of keys based on the desired appearance and overall configuration of the electronic device.

Thus, an embodiment of the invention as defined herein describes a modified data entry keypad for use a mobile telephone or other electronic device. The keypad uses all twenty-six letters of the alphabet, spaced in three rows of a standard QWERTY keyboard. The keypad further includes a first row of keys, each key including a letter pair such that the first letter and second letter in each pair are positioned in a horizontally offset manner. A second row of keys is positioned below the first row of keys, where each key includes a letter pair positioned in a horizontally offset manner such that a first letter of the pair is aligned with a first letter in each pair of the first row and a second letter of the pair is aligned with the second letter in each of the first row. A third row of keys is positioned below the second row of keys, where each key includes a letter pair positioned in a horizontally offset manner such that the first letter of the pair is aligned with the first letter in each pair of the first row and second row, and a second letter of the pair is aligned with the second letter in each of the first row and the second row such that the first row, second row, and third row form a 5×3 matrix of keys.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A data entry interface for use with an electronic device forming a matrix of keys using all twenty-six letters of the alphabet comprising:
a first row of keys having a first group of letters and a second group of letters that are horizontally offset from the first group of letters;
a second row of keys positioned below the first row of keys having a third group of letters and fourth group of letters such that the third group of letters are vertically aligned with the first group of letters and the second group of letters are vertically aligned with the second group of letters; and
a third row of keys positioned below the second row of keys having a fifth group of letters and sixth group of letters such that the fifth group of letters is vertically aligned with the first group of letters and third group of letters and the sixth group of letters is vertically aligned with the second group of letters and fourth group of letters.

2. A data entry interfaces as in claim 1, wherein the matrix is a 5×3 matrix.

3. A data entry interface as in claim 1, wherein the first group of letters is Q, E, T, U, and O.

4. A data entry interface as in claim 3, wherein the second group of letters is W, R Y, I, and P.

5. A data entry interface as in claim 4, wherein the third group of letters is A, D, G, J, and L.

6. A data entry interface as in claim 5, wherein the fourth group of letters is S, F, H, and K.

7. A data entry interface as in claim 6, wherein the first group of letters is Z, C, B, and M.

8. A data entry interface as in claim 7, wherein the sixth group of letters is X, V, and N.

9. A data entry interface as in claim 1, wherein the second row includes a key having an enter function.

10. A data entry interface as in claim 1, wherein the third row includes a key having a space function.

11. A data entry interface as in claim 1, wherein the electronic device is a mobile telephone.

12. A modified data entry keypad for a mobile telephone using all twenty-six letters spaced in three rows of a standard QWERTY keyboard comprising:
a first row of keys each key including a letter pair such that the first letter and second letter in each pair are positioned in a horizontally offset manner;
a second row of keys positioned below the first row of keys where each key includes a letter pair positioned in a horizontally offset manner such that a first letter of the pair is vertically aligned with a first letter in each pair of the first row and a second letter of the pair is vertically aligned with the second letter in each of the first row;
a third row of keys positioned below the second row of keys where each key includes a letter pair positioned in a horizontally offset manner such that the first letter of the pair is vertically aligned with the first letter in each pair of the first row and second row, and a second letter of the pair is vertically aligned with the second letter in each of the first row and the second row; and
wherein the first row, second row, and third row form a 5×3 matrix of keys.

13. A modified data entry keypad as in claim 12, wherein the letter pairs in the first row of keys are QW, ER, TY, UI, and OP.

14. A modified data entry keypad as in claim 12, wherein the letter pairs in the second row of keys are AS, DF, GH, and JK.

15. A modified data entry keypad as in claim 12, wherein the letter pairs in the third row of keys are ZX, CV, and BN.

16. A modified data entry keypad as in claim 12, wherein the letter L is in the second row of keys.

17. A modified data entry keypad as in claim 12, wherein the letter M is in the third row of keys.

18. A modified data entry keypad as in claim 12, wherein the second row includes a key having an enter function.

19. A modified data entry keypad as in claim 12, wherein the third row includes a key having a space function.

20. A keyboard for use with an electronic device having twenty-six letters of a standard three row QWERTY keyboard comprising:
a first row having a first group of letters;
a second row positioned below the first row having a second group of letters that are horizontally offset from the first group of letters;
a third row positioned below the second row having a third group of letters that are vertically aligned with the first group of letters;
a fourth row positioned below the third row having a fourth group of letters that are vertically aligned with the second group of letters;
a fifth row positioned below the fourth row having a fifth group of letters that are vertically aligned with the first group of letters and third group of letters; and
a sixth row positioned below the fifth row having a sixth group of letters that are vertically aligned with the second group of letters and the fourth group of letters.

21. A keyboard as in claim 20, wherein the first group of letters is Q, E, T, U, and O.

22. A keyboard as in claim 21, wherein the second group of letters is W, R Y, I, and P.

23. A keyboard as in claim 22, wherein the third group of letters is A, D, G, J, and L.

24. A keyboard as in claim 23, wherein the fourth group of letters is S, F, H, and K.

25. A keyboard as in claim 24, wherein the firth group of letters is Z, C, B, and M.

26. A keyboard as in claim 25, wherein the sixth group of letters is X, V, and N.

27. A keyboard as in claim 20, wherein first row and the second row are placed on a single set of keys such that the letters QW, letters ER, letters TY, letters UI, and letters OP are each paired on respective keys.

28. A keyboard as in claim 20, wherein the third row and fourth row are placed on a single set of keys such that the letters AS, letters DF, letters GH, and letters JK are each paired on respective keys.

29. A keyboard as in claim 20, wherein the fifth row and sixth row are positioned on a single set of keys such that letters ZX, letters CV, and letters BN are each paired on respective keys.

30. A keyboard as in claim 20, wherein the fourth row includes a key having an enter function.

31. A keyboard as in claim 20, wherein the sixth row includes a key for the space function.

32. A keyboard as in claim 20, wherein the electronic device is a mobile telephone.
